(19) United States
(12) Patent Application Publication
(10) Pub. No.: US 2007/0153668 A1
(43) Pub. Date: Jul. 5, 2007

(54) Data storage device utilizing carbon nanotubes and method for operating

(75) Inventors: Yuh-Wen Lee, Hsinchu (TW); Ching-Hsing Tsai, Taipei (TW); Ching-Yi Wu, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Industrial Technology Research Institute

(21) Appl. No.: 11/602,471

(22) Filed: Nov. 20, 2006

Related U.S. Application Data
(63) Continuation-in-part of application No. 10/335,307, filed on Dec. 31, 2002, now abandoned.

(51) Int. Cl. G11B 9/00

(52) U.S. Cl. 369/126

(57) ABSTRACT

The present invention provides a data storage device that includes a medium capable of recording information, a movable arm above the medium, a carbon nanotube, a driving electrode and a focusing electrode between the driving electrode and the medium. The movable arm has a conductive micro-tip above a first area of the medium and capable of accessing the information recorded in the medium. The carbon nanotube extends from the conductive micro-tip toward a direction of the medium. The driving electrode is between the conductive micro-tip and the medium, providing an opening between the conductive micro-tip and the medium, and is capable of driving electrons from the carbon nanotube toward the direction of the medium. Further, the focusing electrode is between the driving electrode and the medium, providing an opening between the conductive micro-tip and the medium, and is capable of focusing electrons passing through the focusing electrode opening.

### CROSS-REFERENCE TO RELATED APPLICATIONS

The present application is a continuation-in-part of copending U.S. application Ser. No. 10/335,307 filed Dec. 31, 2002 entitled “Data storage device utilizing carbon nanotubes and method for operating”, which is hereby incorporated by reference herein in its entirety.

### BACKGROUND OF THE INVENTION

The present invention generally relates to a data storage device and method for operating the device, more particularly, relates to a data storage device equipped with carbon nanotubes formed on silicon micro-tips for data read/write and method for operating the silicon micro-tips.

In recent years, carbon nanotubes have been developed for applications in field emission display panels as electron emitters. Carbon nanotubes, utilized in such applications, are normally formed in hollow tubes which are either single-walled or multi-walled nanotubes. The carbon nanotubes, after being fractured, may have a length between about 1 and about 3 μm. The nanotubes may have an outside diameter between about 5 and about 50 nanometers which relates to an aspect ratio of about 100, when the length is 1 μm and the diameter is 10 nm.

Based on the large aspect ratios of the carbon nanotubes, made possible by the fact that the length of the nanotube is substantially larger than its diameter, the carbon nanotubes are ideal electron emitters. When a small electrical voltage is applied to the tips of the carbon nanotubes, electrons are emitted forming an electron beam having a diameter smaller than 100 Å. Carbon nanotubes therefore make an ideal field emission source. A single carbon nanotube can be used as an electron emitter for emitting electron beams of very high resolution. However, the use of the carbon nanotubes has not been extensively investigated outside the technical field of the field emission display devices.

The technique of MEMS (Micro-Electro-Mechanical-System) also being developed recently for the fabrication of microscopic-scaled machine parts, i.e., in the dimension of micrometers. The MEMS technology has been extended to the semiconductor fabrication industry. For instance, a semiconductor device can be formed in a planar structure by a planar process. Layers of different materials, i.e., insulating materials and metallic conductive materials, may be deposited on top of one another and then features of the device are etched through the various layers. More recently, 3-dimensional structure of semiconductor devices have also been fabricated by the MEMS technique.

Data storage devices and method for storing massive amounts of data have been important aspects in modern data processing technologies. A key element in data storage devices is the read/write function and the method for reading/writing data from/into the storage device. Conventionally, the element for reading/writing data from/into a data storage device is a laser beam or a magnetic head. In most instances, a thin probe needle must be used in carrying out such read/write function. The probe needle can easily be damaged when accidentally collided with the surface of a magnetic medium. Moreover, the probe needle wears out easily after long time usage. The technique to fabricate such probe needle in order to achieve resolution at the atomic level is also difficult. It is therefore desirable to provide an element for data read/write that does not utilize the traditional laser beam or magnetic head and for avoiding direct physical contact with a recording medium

### BRIEF SUMMARY OF THE INVENTION

In accordance with the various embodiments of the present invention, a method for read/write data onto a recording medium by using a nano-tip array and a data storage device containing such nano-tip array are disclosed

In one example, the present invention provides a data storage device that includes a medium capable of recording information, a movable arm above the medium, a carbon nanotube, a driving electrode, and a focusing electrode between the driving electrode and the medium. The movable arm has a conductive micro-tip on a portion of the movable arm, and the conductive micro-tip is above a first area of the medium and capable of accessing the information recorded in the medium. The carbon nanotube extends from the conductive micro-tip toward a direction of the medium. The driving electrode is between the conductive micro-tip and the medium, providing an opening between the conductive micro-tip and the medium, and is capable of driving electrons from the carbon nanotube toward the direction of the medium. Further, the focusing electrode is between the driving electrode and the medium, providing an opening between the conductive micro-tip and the medium, and is capable of focusing electrons passing through the focusing electrode opening.

Examples of the present invention may also provide a data storage device that includes a medium capable of recording information, an arm extending above the medium with a portion of the arm having a conductive micro-tip thereon, a driving electrode, and a focusing electrode between the driving electrode and the medium. The conductive micro-tip extends toward a first area of the medium and is capable of accessing the information recorded in the medium. The driving electrode is between the conductive micro-tip and the medium, providing an opening between the conductive micro-tip and the medium, and is capable of driving electrons from the carbon nanotube toward the direction of the medium. Further, the focusing electrode provides an opening between the conductive micro-tip and the medium, and is capable of focusing electrons passing through the focusing electrode opening.

Examples of the present invention may further provide a data storage device that includes a medium capable of recording information, a conductive micro-tip above a first area of the medium and capable of accessing the information recorded in the medium, a driving electrode between the conductive micro-tip and the medium, and a focusing electrode between the driving electrode and the medium. The driving electrode provides an opening between the conductive micro-tip and the medium, and is capable of driving electrons from the carbon nanotube toward the direction of the medium. And the focusing electrode provides an opening between the conductive micro-tip and the medium, and is capable of focusing electrons passing through the focusing electrode opening.

Examples of the present invention may still further provide a method for accessing data recorded in a medium. The method includes steps of providing a first electrical field between a micro-tip and a driving electrode to cause electrons to be emitted from the micro-tip to the medium, a first area of the medium being below the micro-tip, providing a second electrical field between the micro-tip and the medium to attract the electrons toward the medium through the driving electrode opening, and providing a third electrical field between the micro-tip and a focusing electrode to adjust a diameter of an electron beam containing the electrons. In the method, the driving electrode provides an opening between the micro-tip and the medium and being under the micro-tip, the focusing electrode is under the driving electrode and provides an opening between the micro-tip and the medium, and the electron beam is projected from the micro-tip toward the medium through the focusing electrode opening.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a graph illustrating a present invention data storage device utilizing carbon nanotubes;

FIG. 2 is an enlarged, cross-sectional view of a present invention silicon micro-tip formed by a MEMS technique and coated with at least one carbon nanotube by CVD or electrodeposition;

FIG. 3 is a perspective view of the present invention data storage device including a multiplicity of silicon micro-tips each coated with at least one carbon nanotube;

FIG. 4 is a perspective view of another embodiment of the present invention illustrating a multiplicity of silicon micro-tips, each coated with at least one carbon nanotube;

FIG. 5 is a perspective view of the present invention embodiment of FIG. 4 engaging an anode positioned juxtaposed on top; and

FIG. 6 is an enlarged, cross-sectional view of another embodiment of the present invention data storage device.

### DETAILED DESCRIPTION OF THE INVENTION

Examples of the present invention provide a method for read/write data onto a recording medium by using a nano-tip array by first fabricating a silicon micro-tip array including a multiplicity of silicon micro-tips by a MEMS method and then forming integrally on each one of the multiplicity of silicon micro-tips at least one carbon nanotube extending outwardly away from the micro-tip. A recording medium is then positioned next to the silicon micro-tip array and rotated for scanning by the micro-tip array. An electrical current is flown to the at least one carbon nanotube when the at least one carbon nanotube engages the recording medium to effectuate the date read/write function.

Examples of the present invention also include a data storage device which includes a silicon micro-tip array, at least one carbon nanotube formed integrally on each one of the multiplicity of silicon micro-tips, an anode with a multiplicity of apertures formed therein, and a recording medium that rotates when positioned immediately adjacent to the silicon micro-tips.

Other example of the present invention also include a method for fabricating a silicon micro-tip array with at least one carbon nanotube integrally formed on each one of the silicon micro-tips which can be carried out by first fabricating a silicon micro-tip array by a MEMS technique and then forming integrally on each one of the multiplicity of silicon micro-tips at least one carbon nanotube extending outwardly away from the micro-tip. The formation of the carbon nanotube can be achieved by a variety of methods including chemical vapor deposition and electrodeposition.

A data storage device may be fabricated by combining a micro-electro-mechanical system method and a carbon nanotube formation method to form a nano-tip array on a semiconductor wafer. A piezoelectric thin film is incorporated in the MEMS method during the semiconductor fabrication for forming a suspended arm and a silicon micro-tip formed at a free end of the arm. After carbon nanotubes are formed on the silicon micro-tips, the piezoelectric thin film activates the micro-tip and thus enables electrons to be emitted from carbon nanotubes onto the surface of a recording medium. A thin film coated on the recording medium, under the bombardment of the electron, changes its magnetic property to achieve a high density data storage function, i.e., data read/write function.

By utilizing the present invention silicon micro-tip array coated with carbon nanotubes, a minute electron beam smaller than 100 Å can be produced when a low voltage current is flown to the carbon nanotubes. The device may utilize collimating lenses or magnetic field to control the size and movement of the electron beam in order to achieve data read/write and data storage. Since the present invention silicon micro-tip array coated with carbon nanotubes does not have physical contact with the surface of the recording medium, there is no physical wear on the carbon nanotubes which further improves the reliability and durability of the silicon micro-tip array. The minute size of electron beam produced further improves the resolution of read/write and enables high density recording to be executed.

A method can be carried out by first fabricating silicon micro-tip array on a semiconductor wafer by a MEMS technique. A catalytic chemical vapor deposition technique or an electrodeposition technique can then be used to integrally form carbon nanotubes on the tips of the silicon micro-tips.

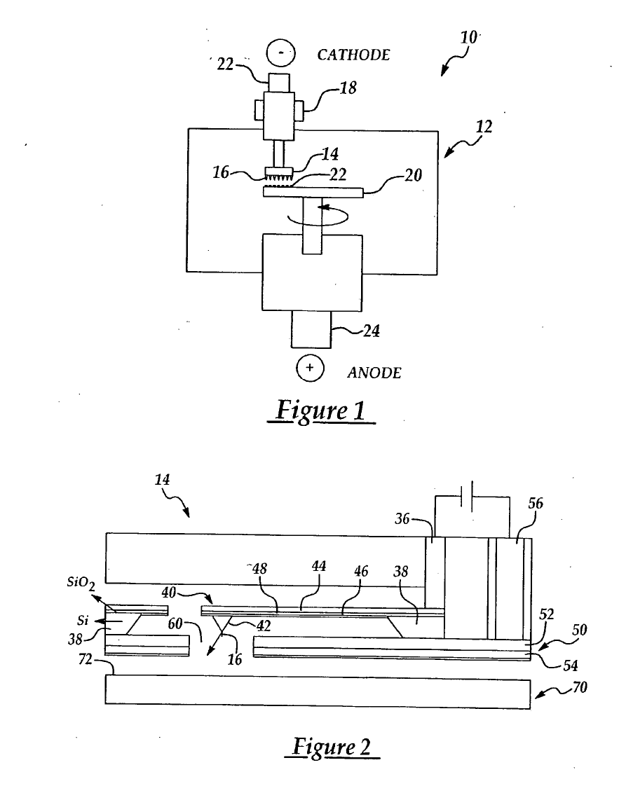

Referring initially to FIG. 1, which illustrates a data storage, read/write device 10. A suspended arm, or cantilever beam 40 formed by a MEMS technique is shown is FIG. 2. As shown in FIG. 1, the major components in the present invention data storage device 10 are a vacuum chamber 12, a nano-tip array 14 equipped with carbon nanotubes 16, a collimating lens system 18, a magnetic recording medium 22 positioned on a rotation means 20, a cathode 22 and an anode 24. The nano-tip array 14 is formed by a multiplicity of silicon micro-tips that are coated with at least one carbon nanotubes 16. The carbon nanotubes 16 are used as the electron emitter for producing a small electron beam at very low electrical voltage. The electrical voltage required is between about 3 and about 5 volts capable of producing an electron beam of stable current density during a prolonged period of time, i.e., longer than several hundred hours. The present invention data storage device 10 provides high sensitivity, high accuracy and high reliability by using carbon nanotubes for read/write onto a recording medium an electron beam in the nanometer scale to change the magnetic property of the recording medium in order to achieve high density read/write, and furthermore, a super high density recording medium

FIG. 2 illustrates an exemplary method for forming a silicon micro-tip array by a MEMS technique. An etchant of KOH is used for etching and forming the silicon micro-tip 42 according to the crystal planes of (100) and (111) of the silicon crystal forming a sharp tip. The MEMS method further produces a cantilever beam 40 by lithographic and etching methods forming a micro-actuated thin film 44 of AIN on top of an insulating SIO.sub.2 layer 46 and a gate oxide layer 48, sequentially. An anode 50 is formed of a layer 52 of conductive metal and an insulating material layer 54, such as SIO.sub.2. Apertures 60 are formed in the anode 50 with each corresponding to a single silicon micro-tip 42. A positive current is flown to the anode 52, during operation of the data read/write to control the size and velocity of the electron beam emitted from the carbon nanotube 16. It should be noted that the cantilever beam 40 is formed on the silicon substrate 38. During the MEMS process, electrodes formed of a conductive metal, such as tungsten or any other suitable metal are formed by electroplating. For instance, as shown in FIG. 2, tungsten via 56 is formed for the anode 50 and tungsten via 36 is formed for the cathode, i.e., the cantilever arm 40.

Also shown in FIG. 2, is a recording medium 70 which is position juxtaposed, or immediately adjacent to the silicon micro-tip 42 and the anode 50 for receiving, on a top surface 72 electron beam emitted from the carbon nanotube 16. The electron beam thus changes the magnetic property of a thin film that is coated on the top surface 72 of the recording medium 70 achieving the data read/write result.

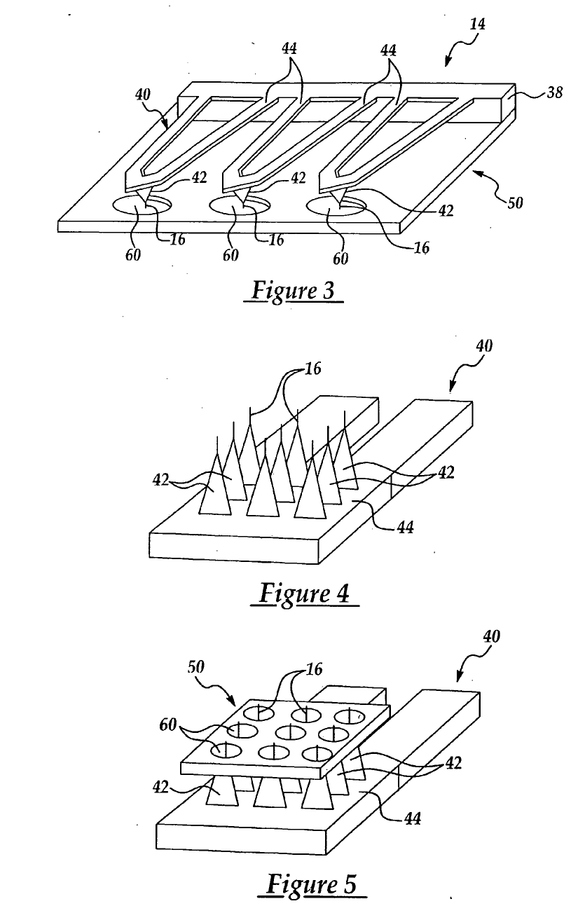

FIG. 3 is a perspective view of the present invention data read/write device 14 with three cantilever arms 40 shown. With the multiple silicon micro-tips 42, a higher density data read/write can be achieved. Similarly, FIGS. 4 and 5 illustrates another embodiment wherein nine silicon micro-tips 42 are shown, each being formed integrally with a single carbon nanotube 16. It should be noted that the cantilever arm 40 is formed in a slightly different configuration, when compared to that shown in FIG. 3. An anode 50 provided with a multiplicity of apertures 60 is further shown in FIG. 5 illustrating the corresponding relationship between the carbon nanotubes 16 and the apertures 60.

The present invention MEMS method can be carried out for fabricating silicon micro-tip array on a silicon on insulator (SOI) wafer by first growing a layer of Si.sub.3N, by a low pressure chemical vapor deposition (LPCVD) technique. The silicon nitride layer is used as a hard mask during the silicon etching process for forming the silicon tip 42 (shown in FIG. 2). A photolithographic method is then used for etching away Si.sub.3N.sub.4 in patterned windows by a reactive ion etching technique. The RIE technique is carried out by an aqueous solution of KOH at 75.degree. C. which enables a slower etch rate on the silicon (111) crystal plane compared to the (100) crystal plane. As a result, the silicon substrate is etched by the KOH etchant forming a sharp-pointed silicon tip 42 with a 54.7 degree angle.

In the next step of the process, an HF aqueous solution is used to remove the residual Si.sub.3N.sub.4 to finalize the structure of the silicon micro-tips. By accurate alignment of the SOI wafer and wafer backside silicon crystal etching, materials are removed on the SOI wafer backside such that a cantilever beam 40 formed of SiO.sub.2 is left on the wafer backside. A reactive sputtering technique is then used to sputter coating a piezoelectric material on the SiO.sub.2 to form the cantilever beam 40. A suitable piezoelectric material used is AIN. The various embodiments of the formation of the cantilever beams are shown in FIGS. 3, 4 and 5, while a single silicon tip is shown in FIG. 2. Collimating lenses, shown in FIG. 1 by numeral 18, are used to collimate the electron beams.

The second major step for the fabrication of the present invention data read/write device is the growth of the carbon nanotubes, integrally with the silicon tip 42. The carbon nanotube growth and mounting technology can be achieved by first fabricating the carbon nanotubes utilizing two graphite electrodes in an inert gas environment of helium or argon. A direct current is flown to the graphite electrodes to produce an electrical charge between the electrodes. The carbon nanotubes may further be grown in a high-temperature temperature furnace on top of fine metal grains of a catalyst such as Fe or Co. A chemical process for fracturing CH.sub.4 or C.sub.2H.sub.6 is then used for fabricating the carbon nanotubes.

For instance, the catalytic chemical vapor deposition technique can be used to selectively grow carbon nanotubes on surfaces that are only coated with a fine grained catalyst, i.e., on top of the silicon micro-tip, such as Fe, Co, Ni, Pt, Pd or Ir. The SOI wafer is then placed in a high-temperature furnace, such as one kept at 800.degree. C., and a suitable flow of H.sub.2, Ar and C.sub.2H.sub.6 are then flown into the furnace tube. The carbon nanotubes are then grown, or deposited by a catalytic reaction by the chemical vapor deposition technique on top of the silicon micro-tips. A bundle, i.e., more than one, of carbon nanotubes is normally grown on the silicon tips. The longer the reaction time allowed, the larger the length of the carbon nanotubes are formed. After the growth of the carbon nanotube is completed, the SOI wafer is placed in ethanol for purification and then surface activated such that the carbon nanotubes are grouped together forming a single sharp tip. An illustration of the sharp tip is shown in FIG. 4.

In the second method for forming the carbon nanotubes, i.e., the self-assembly method or the electrodeposition method, carbon nanotubes are first placed in an electrolyte solution such that the nanotubes are dispersed evenly. A SOI wafer coated with a conductive Ni layer on top is then placed in the electrolyte with the Ni layer as an electrode. A DC current is then applied such that electrical field is formed at the tip of the silicon micro-tips. The electric field formed attracts the carbon nanotubes dispersed in the electrolyte solution and thus combine with the silicon micro-tips due to electrical interaction. After the SOI wafer is removed from the electrolyte solution and treated for surface activation in order to group the carbon nanotubes, a sharp-pointed bundle of carbon nanotubes is formed.

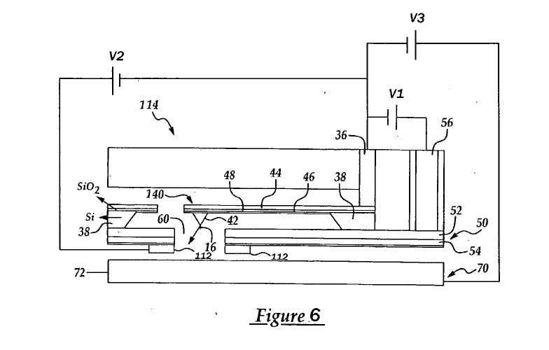

FIG. 6 illustrates another example of a data storage device. Referring to FIG. 6, data storage device 114 may include a recording medium 70 capable of recording information, a movable arm 40 above the medium 70, a carbon nanotube 16 extending from a conductive micro-tip 42 of the movable arm 40 toward a direction of the medium 70, a driving electrode 50 between the conductive micro-tip 42 and the medium 70, and a focusing electrode 112 between the driving electrode 50 and the medium 70. Further, the conductive micro-tip 42 of the movable arm 40 is on a portion of the movable arm 40, and is above a first area of the medium 70. Hence the conductive micro-tip 42 is capable of accessing the information recorded in the medium 70. The driving electrode 50 provides an opening between the conductive micro-tip 42 and the medium 70, and is capable of driving electrons from the carbon nanotube 16 toward the direction of the medium 70. And the focusing electrode 112 provides an opening between the conductive micro-tip 42 and the medium 70, and is capable of focusing electrons passing through the focusing electrode opening.

In the data storage device 114 according to the embodiment of the present invention shown in FIG. 6, the movable arm 40 may include one of AIN and a piezoelectric material, and may be capable of being controlled electrically to adjust a distance between the carbon nanotube 16 and the medium 70. The carbon nanotube 16 may be formed integrally with the conductive micro-tip 42, and the carbon nanotube 16 may produce an electron beam containing the electrons, wherein the electron beam may have a diameter of no more than 100 Å. In addition, the diameter of the electron beam projected onto the medium 70 from the carbon nanotube 16 may be controllable by the focusing electrode 112.

As illustrated in FIG. 6, there are three electrical field, V1, V2 and V3, provided in the data storage device 114 according to the embodiment of the present invention. The first electrical field V1 is provided between the carbon nanotube 16 and the driving electrode 50 to cause the carbon nanotube 16 to emit the electrons. The second electric field V2 is provided between the carbon nanotube 16 and the focusing electrode 112 to control directions of the electrons emitted from the carbon nanotube 16. And the third electric field V3 is provided between the carbon nanotube 16 and the medium 70 to attract the electrons toward the medium 70. The directions of the electrons emitted from the carbon nanotube 16 can be further adjusted by controlling the position of the movable arm 40 and hence the carbon nanotube 16 thereon.

In the example of the present invention, the position of the movable arm 40 and the distance between the movable arm 40 and the medium 70 may be controlled to change. First of all, at least one of the medium 70 and the movable arm 40 is coupled with a moving mechanism capable of moving another area of the medium to a location under the conductive micro-tip 42. In addition, according to examples of the present invention, the movable arm 40 may comprise at least two materials of different coefficients of thermal expansion. Hence the movable arm 40 may bend when a controlling temperature is provided, and the position of the movable arm 40 and the distance between the movable arm 40 and the medium 70 is changed accordingly.

Depending on the designs and applications, examples of the invention may provide a data storage device overcoming or reducing the drawbacks or shortcomings of the conventional data storage and data read/write devices. A data storage device may include a read/write element of a multiplicity of silicon micro-tips each formed on a suspended arm formed of piezoelectric material. In some examples, one or more carbon nanotubes may be formed integrally with one or more of the micro-tips. In some examples, the carbon nanotube may be integrally formed by chemical vapor deposition or electrodeposition.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A data storage device comprising:
a medium capable of recording information;
a movable arm above the medium, the movable arm having a conductive micro-tip on a portion of the movable arm, the conductive micro-tip being above a first area of the medium and being capable of accessing the information recorded in the medium;
a carbon nanotube extending from the conductive micro-tip toward a direction of the medium;
a driving electrode between the conductive micro-tip and the medium, the driving electrode providing an opening between the conductive micro-tip and the medium and being capable of driving electrons from the carbon nanotube toward the direction of the medium; and
a focusing electrode between the driving electrode and the medium, the focusing electrode providing an opening between the conductive micro-tip and the medium, the focusing electrode capable of focusing electrons passing through the focusing electrode opening.

2. The data storage device according to claim 1, wherein the movable arm comprises one of AIN and a piezoelectric material.

3. The data storage device according to claim 1, wherein the movable arm is capable of being controlled electrically to adjust a distance between the carbon nanotube and the medium.

4. The data storage device according to claim 1, the carbon nanotube is formed integrally with the conductive micro-tip.

5. The data storage device according to claim 1, wherein at least one of the medium and the movable arm is coupled with a moving mechanism capable of moving a second area of the medium to a location under the conductive micro-tip.

6. The data storage device according to claim 1, wherein the carbon nanotube produces an electron beam containing the electrons, the electron beam having a diameter of no more than 100 Å.

7. The data storage device according to claim 1, wherein the focusing electrode is capable of controlling a diameter of an electron beam projected onto the medium from the carbon nanotube.

8. The data storage device according to claim 1, wherein a first electrical field is provided between the carbon nanotube and the driving electrode to cause the carbon nanotube to emit the electrons.

9. The data storage device according to claim 1, wherein a second electric field is provided between the carbon nanotube and the focusing electrode to control directions of the electrons emitted from the carbon nanotube.

10. The data storage device according to claim 1, wherein a third electric field is provided between the carbon nanotube and the medium to attract the electrons toward the medium.

11. The data storage device according to claim 1, wherein said movable arm comprises at least two materials of different coefficients of thermal expansion.

12. A data storage device comprising:
a medium capable of recording information;
an arm extending above the medium, a portion of the arm having a conductive micro-tip thereon, the conductive micro-tip extending toward a first area of the medium and being capable of accessing the information recorded in the medium;
a driving electrode between the conductive micro-tip and the medium, the driving electrode providing an opening between the conductive micro-tip and the medium and being capable of driving electrons from the carbon nanotube toward the direction of the medium; and
a focusing electrode between the driving electrode and the medium, the focusing electrode providing an opening between the conductive micro-tip and the medium, the focusing electrode capable of focusing electrons passing through the focusing electrode opening.

13. A data storage device comprising:
a medium capable of recording information;
a conductive micro-tip above a first area of the medium and capable of accessing the information recorded in the medium;
a driving electrode between the conductive micro-tip and the medium, the driving electrode providing an opening between the conductive micro-tip and the medium and being capable of driving electrons from the carbon nanotube toward the direction of the medium; and
a focusing electrode between the driving electrode and the medium, the focusing electrode providing an opening between the conductive micro-tip and the medium, the focusing electrode capable of focusing electrons passing through the focusing electrode opening.

14. A method for accessing data recorded in a medium, the method comprising:
providing a first electrical field between a micro-tip and a driving electrode to cause electrons to be emitted from the micro-tip to the medium, a first area of the medium being below the micro-tip, the driving electrode having providing an opening between the micro-tip and the medium and being under the micro-tip;
providing a second electrical field between the micro-tip and the medium to attract the electrons toward the medium through the driving electrode opening; and
providing a third electrical field between the micro-tip and a focusing electrode to adjust a diameter of an electron beam containing the electrons, the focusing electrode being under the driving electrode and providing an opening between the micro-tip and the medium, the electron beam being projected from the micro-tip toward the medium through the focusing electrode opening.

15. The method of claim 14, further comprising adjusting the distance between the micro-tip and the medium through adjusting an arm movement of an arm extended above the medium and having the micro-tip formed thereon.

16. The method of claim 15, wherein adjusting the arm movement comprises using an arm having at least two materials of different coefficients of thermal expansion and adjusting the arm movement by controlling a temperature of the at least two materials.

17. The method of claim 14, further comprising moving the micro-tip and the medium relatively so that a second area of the medium is under the micro-tip.

18. The method of claim 14, further comprising changing the first electric field between the driving electrode and the micro-tip to achieve at least one of writing the data to the medium and erasing the data from the medium.

19. The method of claim 14, further comprising reading data from the medium by measuring a difference in conductivity of the medium.

20. The method of claim 14, further comprising using the micro-tip with a carbon nanotube extended therefrom toward the medium.
